(19) United States
(12) Patent Application Publication
(10) Pub. No.: US 2023/0325744 A1
(43) Pub. Date: Oct. 12, 2023

(54) Construction robot, construction robot system and method for controlling a construction robot system

(71) Applicant: Hilti Aktiengesellschaft, Schaan (LI)

(72) Inventors: Peter BRUGGER, Feldkirch (AT); Sascha KORL, Buchs (CH); Nitish KUMAR, Buchs (CH); Julia ZANONA, Feldkirch (AT)

(21) Appl. No.: 18/028,131

(22) PCT Filed: Oct. 5, 2021
(86) PCT No.: PCT/EP2021/077419

§ 371 Date: Mar. 23, 2023

(30) Foreign Application Priority Data
Oct. 9, 2020 (EP) 20200965.0

(51) Int. Cl. G06Q 10/0631; G06Q 50/08; B25J 9/16

(52) U.S. Cl. CPC G06Q 10/06316; G06Q 50/08; B25J 9/1661

(57) ABSTRACT

A construction robot for performing construction tasks on a construction site, in particular a building construction site and/or a civil engineering construction site, comprising at least one manipulator for performing a construction task, an internal construction task management system, which is set up to store an internal construction task list of the construction robot in a retrievable manner, the internal construction task list comprising one or more construction tasks to be performed by the construction robot on the construction site, and a communication interface for communication with an external construction task management system, the external construction task management system being set up to store an external construction task list in a retrievable manner, the external construction task list comprising one or more construction tasks to be performed on the construction site, the construction robot being set up to send at least one construction task and/or a construction task status of a construction task of the internal construction task list to the external construction task management system via the communication interface. The invention further comprises a construction robot system and a method for controlling at least one construction robot of a construction robot system. The invention makes it possible for construction tasks to be performed on a construction site in a documented manner.

### BACKGROUND

The invention is based on a construction robot for performing construction tasks on a construction site, in particular a building construction site and/or a civil engineering construction site, comprising at least one manipulator for performing a construction task, as known for example from the publication WO 2016/066615 A2. The invention further relates to a construction robot system and a method for controlling at least one construction robot of a construction robot system.

### SUMMARY OF THE INVENTION

With the help of so-called Building Information Modeling (hereinafter: BIM) planning systems, planning data for buildings to be constructed can be compiled. These planning data usually comprise various construction tasks that have to be performed to construct the building. These planning data are usually stored in central databases. The planning data are selected manually by different persons entrusted with performing the construction tasks; the selected construction tasks are performed by these persons. In order to inform various interest groups, the construction progress achieved in each case is recorded manually and noted in the planning data. This creates additional processing effort, which significantly reduces the benefits of introducing a BIM planning system.

It would be desirable if the construction progress in relation to construction tasks to be performed could be automatically mapped in the planning data.

An object of the present invention is therefore to offer a robot, a construction robot system and a method for controlling a construction robot that make it possible for construction tasks from a construction task list to be performed in a documented manner.

The present invention provides a construction robot for performing construction tasks on a construction site, in particular a building construction site and/or a civil engineering construction site, comprising at least one manipulator for performing a construction task, an internal construction task management system, which is set up to store an internal construction task list of the construction robot in a retrievable manner, the internal construction task list comprising one or more construction tasks to be performed by the construction robot on the construction site, and a communication interface for communication with an external construction task management system, the external construction task management system being set up to store an external construction task list in a retrievable manner, the external construction task list comprising one or more construction tasks to be performed on the construction site,
the construction robot being set up to send at least one construction task and/or a construction task status of a construction task of the internal construction task list to the external construction task management system via the communication interface.

The construction robot may have a mobile platform.

The mobile platform may be designed as a vehicle. For this purpose, it may have a wheeled undercarriage, in particular at least one wheel, and/or a track-chain undercarriage, in particular comprising at least one chain. It may be designed to be movable in at least one plane.

The mobile platform may also be capable of flying. In other words, the construction robot may be designed as a flying object, in particular as an unmanned flying object. For example, the mobile platform can be designed as a multicopter and/or have such a multicopter.

The manipulator may be designed as a working arm, preferably with an end effector, and/or comprise such a working arm. The working arm may have multiple joints. The end effector may be set up to hold a power tool, for example a hammer drill. Alternatively or additionally, a power tool, for example a hammer drill, may be formed on the end effector. The manipulator may also be designed as a suspension, for example comprising a cardan joint, and/or comprise such a suspension. The suspension may be designed for example as a gimbal and/or comprise such a gimbal. The manipulator may have at least 6 degrees of freedom, in particular at least 3 positional degrees of freedom and at least 3 locational degrees of freedom. The manipulator may be motorized and/or be movable with motor assistance. The manipulator may have at least one hydraulic final control element, a pneumatic final control element and/or a rod-shaped final control element, for example a linear actuator. The manipulator may have a lifting device, in particular in order to be able to additionally set, in particular change, the position of the end effector.

A construction task may comprise for example creating a borehole, in particular in a ceiling, in a wall and/or in a floor. A construction task may also comprise creating a slot, for example by sawing, demolition work, surface treatment, for example plastering and/or grinding a component at least in certain areas. A construction task may in particular comprise processing of a rock, in particular a concrete element. The construction task may also comprise an inspection of at least one structural element. The inspection may be able to be performed optically, acoustically and/or haptically.

The construction task management systems may in each case comprise a computer unit. It may in particular comprise a storage unit for the retrievable storage of the internal or the external construction task list. For a construction task, a construction task status may in each case also be able to be stored in the construction task list.

A construction task status may correspond to a degree of completion of a construction task assigned to it. The degree of completion may have at least the ordinal scale level. For example, the construction task status may correspond to one of the status values “construction task not yet started”, “construction task is being performed” or “construction task has been performed”. In general, the construction task status may be able to be recorded and/or be recorded on an at least two-stage scale level. The construction task status may also contain or correspond to information about an error. For example, the construction task status may also correspond to an incorrect or incomplete drilling of a borehole or a corresponding need for reworking.

A construction task may comprise recording the status of the construction task. In particular, a construction task comprising an inspection may comprise the recording of the construction task status.

The external construction task management system and the external construction task list may correspond to an internal construction task management system or an internal construction task list of a further, in particular similar, second construction robot and/or comprise said system or said list.

Alternatively, the external construction task management system may correspond to a global construction task management system, in particular with a global construction task list. The external construction task management system may be a BIM planning system. The external construction task list may be in the form of or as part of BIM data or comprise BIM data.

The invention is based on the idea of equipping the construction robot with a communication interface so that it can communicate the construction task and/or its construction task status to the external construction task management system during and/or after a construction task on its internal construction task list has been performed. The external construction task management system can consequently update the external construction task list on the basis of the data received, so that a documented performance of the construction tasks of the internal and/or the external construction task list is made possible.

If the construction robot has a display unit which is set up to display at least one construction task in the internal construction task list, preferably all of the construction tasks in the internal construction task list, and/or at least one construction task status, a user of the construction robot can be informed about the construction tasks currently to be performed by the construction robot by means of the display unit. The display unit is preferably connected to an input unit, so that inputs by the user directly on the construction robot are made possible; for this purpose, the display unit may comprise a touchscreen.

The construction robot may be set up so that at least one construction task in its internal construction task list can be changed, in particular created, amended and/or deleted by the user. It may also be set up to send its internal construction task list or at least changes to the construction task list to the external construction task management system via the communication interface.

The construction robot may also be set up to receive changes to the external construction task list from the external construction task management system via its communication interface.

The communication interface preferably comprises a wireless communication interface, for example an interface known generally as a “WLAN” and/or generally as a “Bluetooth” interface, so that establishing communication by means of the communication interface does not require laying cables or the like and communication is further also possible over greater distances in the range of for example several meters. In particular, it is also conceivable that the communication interface comprises a cellular interface, for example in accordance with a standard generally known as the 2G, 3G, 4G and/or 5G standard, whereby communication over particularly long distances becomes possible.

Alternatively or additionally, the communication interface may also be set up for data transmission by means of a portable storage unit. The portable storage unit may for example be designed in the form of a portable non-volatile memory, such as for example generally known as a USB stick. It may also be part of a portable electronic device, for example a cellular device. Such data transmission may in particular be useful or even necessary on construction sites where wireless communication is not possible or only possible to a limited extent, for example in the case of communication across several floors of an iron-reinforced concrete building.

If the construction robot has a position detection unit for determining its position and/or its location, in particular a position and/or a location of its manipulator, position data thereby recorded can be taken into account, for example when determining the processing sequence of the construction tasks to be performed by the construction robot. Consequently, for example, a total time to complete all of the construction tasks on the construction task list can be reduced.

The construction robot may be set up to receive and/or send at least one position and/or a location, in particular of itself and/or of its manipulator and/or of another construction robot and/or of another manipulator, via the communication interface.

If the construction robot is set up to send at least one measurement data item, in particular a position and/or a location, in particular of itself and/or of its manipulator and/or of another construction robot and/or of another manipulator, via the communication interface, the recipient of the measurement data can, depending on the type of measurement data, for example have further construction tasks to be performed selected for it and/or allocated to it, depending on the position. For example, a construction robot may be primarily assigned those construction tasks that are to be performed in its vicinity. The measurement data itself may also be used for example to complete inspection construction tasks.

It is conceivable, in particular, that the at least one measurement data item is sent to another construction robot. Construction tasks can consequently be able to be performed interactively and/or more quickly.

It is conceivable that the construction robot may be designed to move partially autonomously, in particular under the necessary supervision of a user of the construction robot, or autonomously, in particular without necessary supervision by a user. It may also be designed to perform a construction task partially autonomously or autonomously. While safety requirements on construction sites are easier to meet with construction robots that move partially autonomously and/or perform construction tasks partially autonomously, performance of construction tasks independently of the user is made possible in particular by a construction robot that is designed to move autonomously and at the same time perform construction tasks autonomously.

The communication interface of the construction robot may offer more than one communication channel. In this way, interruptions of work due to poor connection quality on a communication channel can be avoided. For example, the construction robot may be set up to switch to an alternative communication channel, for example to data transmission by means of portable storage units, if there is no data connection to a supra-regional and/or to a local network, in particular a radio network such as a WLAN network.

The scope of the invention may also include a construction robot system for performing construction tasks on a construction site, comprising a first construction robot according to the invention and an external construction task management system, which is set up to store an external construction task list in a retrievable manner, the external construction task list comprising one or more construction tasks to be performed, and the first construction robot being set up to communicate via its communication interface with the external construction task management system. In particular, the first construction robot may be set up to send at least one construction task and/or a construction task status of a construction task from its internal construction task list to the external construction task management system via its communication interface.

The external construction task management system may comprise a BIM planning system. The external construction task list may be designed in the form of or as part of BIM data.

The construction robot system consequently makes it possible for the construction robot to send construction tasks and/or a construction task status to the external construction task management system. The construction tasks of the external construction task list located there can consequently be updated and the construction progress achieved by the construction robot can be documented.

The external construction task management system may comprise a global construction task management system. The construction task management system may be set up to store a global construction task list in a retrievable manner, the global construction task list comprising one or more construction tasks to be performed on the construction site. For this purpose, the global construction task management system may comprise a computer unit with a storage unit for the retrievable storage of the global construction task list. In particular, it may comprise a central database system.

The construction robot system may also comprise at least one second construction robot according to the invention, the external construction task management system comprising the internal construction task management system of the second construction robot. In particular, the external construction task management system may correspond to the internal construction task management system of the second construction robot. The first construction robot can consequently be set up to communicate with the second construction robot via its communication interface. The second construction robot is preferably also set up to communicate with the first construction robot via its communication interface.

It is conceivable that the first construction robot is set up to send at least one construction task and/or at least one construction task status to the second construction robot and/or the global construction task management system via its communication interface. The second construction robot is preferably also set up analogously for communication with the first construction robot and/or the global construction task management system.

The second construction robot can consequently be informed for example about the takeover and/or completion of a construction task by the first construction robot, so that duplication of work by the second construction robot is avoided. As a result of the communication between the first and the second construction robot, it is possible to dispense with the global construction task management system or, in general, a central control system for controlling the first and the second construction robot. Consequently, construction tasks can also be performed in areas of a construction site from which no communication with the global construction task management system and/or the central control system would be possible. This may be the case for example if the communication interface is wireless, but wireless communication at least between the first and/or the second construction robot and the global construction management system and/or the central control system is prevented, for example shielded, for example by reinforced concrete walls, reinforced concrete floors and/or reinforced concrete ceilings. Even in such a situation, the first and the second construction robot can communicate with one another, in particular send at least one construction task and/or at least one construction task status from one of the two construction robots to the other construction robot.

In the case of a global construction task management system, this transmission of information can take place indirectly by means of the global construction task list; in the case of communication between the first and the second construction robot, it can take place directly between the two construction robots.

The construction robot system may comprise a relay station for transmitting at least one construction task and/or at least one construction task status. The relay station may be set up for example for transferring data between a local network, for example a network commonly referred to as “WLAN”, and a supra-regional network, in particular the Internet. The local network, and then preferably also the relay station, may alternatively or additionally be set up for data transmission by means of a portable storage unit.

The first and the at least one second construction robot therefore do not require a direct data connection to the supra-regional network, to which direct data connections, for example in iron-reinforced concrete buildings, can often only be established with reduced connection quality.

The relay station may comprise a computer unit. In particular, it may likewise comprise a storage unit. The global construction task list or at least a copy of the global construction task list may be able to be stored and/or be stored in the storage unit of the relay station. In general, the computer unit may comprise a construction task management system, in particular for managing the global construction task list or at least a copy of the global construction task list. In this way, interruptions of work due to a possibly temporarily poor network connection to the supra-regional network can be avoided.

The global construction task management system may comprise a cloud-based computer unit or be part of the cloud-based computer unit. The global construction task management system may then be able to be connected and/or be connected to the local network, and consequently to the first construction robot and/or the at least one second construction robot, via the supra-regional network and the relay station.

The invention also comprises a method for controlling at least one construction robot of a construction robot system according to the invention, at least one construction task and/or a construction task status of the internal construction task list of the construction robot being sent to the external construction task management system. According to the method, the external construction task list managed by the external construction task management system can be updated by means of the data sent, so that the performance of construction tasks can be documented and/or is documented.

In a variant of the method, at least one construction task and/or a construction task status of the internal construction task list of a first construction robot is sent to the internal construction task management system of a second construction robot.

Alternatively or additionally, a further variant of the method in which at least one construction task and/or a construction task status of the internal construction task list of the first construction robot is sent to the global construction task management system is also conceivable.

The two variants consequently make direct or indirect updating of the internal construction task list of the second construction robot possible. The indirect updating may take place by means of the global construction task list, in particular by sending data to the global construction task management system by the first construction robot and retrieving data from the global construction task management system by the second construction robot.

In particular, it is conceivable that such indirect updating takes place when a data connection with the supra-regional network is available. If the data connection with the supra-regional network is interrupted or completely absent, the updating can take place directly.

If more than one worker, in particular more than one construction robot, is available on a construction site, the problem arises of distributing construction tasks as optimally as possible to the workers available. Distances that have to be covered in particular by a construction robot in order to be able to perform a subsequent construction task always entail a loss of time. There is also an accident risk associated with every distance to be covered on a construction site.

In order to therefore avoid distances to be covered, in one variant of the method it is provided that at least one of the construction robots is transmitted at least one construction task to be performed from the external construction task list, dependent on its respective position and/or its location, in each case.

According to the method, at least one of the construction tasks to be performed on the construction site, in particular one of the construction tasks contained in the global construction task list, may be allocated to at least one of the construction robots by a global construction task management system of the construction robot system.

Alternatively or additionally, at least one of the construction robots may select a construction task to be performed by it from the external, in particular from the global, construction task list.

For the selection, the position and/or the location of the construction robot and/or at least one of the other construction robots may be taken into account. Alternatively or additionally, properties of the construction robot and/or at least one of the other construction robots may also be taken into account. For example, the size of a working area of the manipulator, within which the manipulator can perform construction tasks, may be taken into account. In particular, it is conceivable that several construction tasks, all of which fall within a working area of the construction robot, without the construction robot having to be relocated as a whole, are allocated to the construction robot for being performed or are selected by the construction robot for being performed.

Further features and advantages of the invention emerge from the following detailed description of exemplary embodiments of the invention, with reference to the figures of the drawing, which shows details essential to the invention, and from the claims. The features shown there are not necessarily to be understood as true to scale and are shown in such a way that the special features according to the invention can be made clearly visible. The various features can be implemented individually in their own right or collectively in any combination in variants of the invention.

### BRIEF DESCRIPTION OF THE DRAWINGS

In the schematic drawing, exemplary embodiments of the invention are shown and explained in more detail in the following description.

In the figures:

FIG. 1 shows a construction robot in a schematic representation;

FIG. 2 shows a first construction robot system in a schematic representation;

FIG. 3 shows a second construction robot system in a schematic representation;

FIG. 4 shows a third construction robot system in a schematic representation;

FIG. 5 shows a flow diagram of a method for controlling at least one construction robot of a construction robot system;

FIG. 6 shows a fourth construction robot system in a schematic representation; and

FIG. 7 shows a fifth construction robot system in a schematic representation.

### DETAILED DESCRIPTION

In order to make it easier to understand the invention, the same reference signs are used in each case for identical or functionally corresponding elements in the following description of the figures.

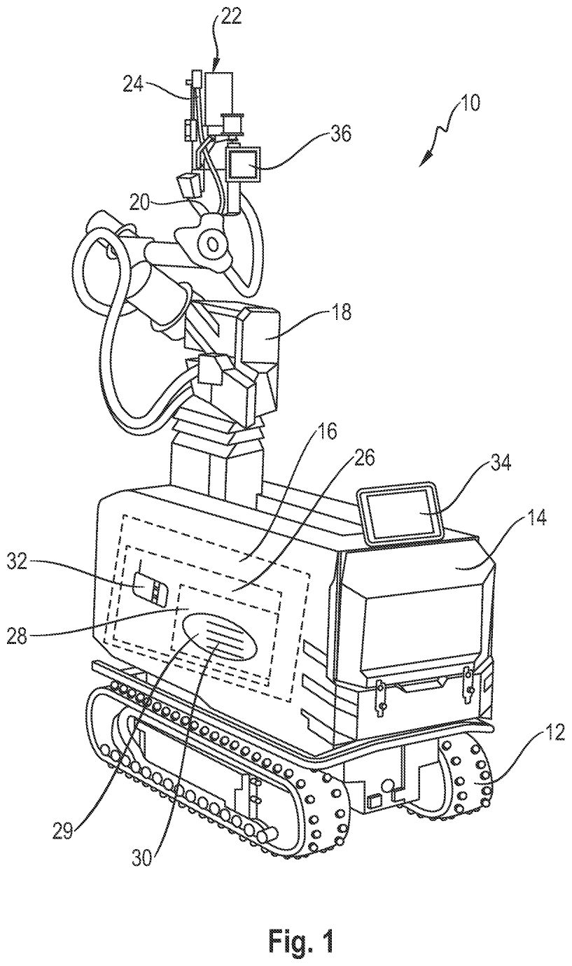

FIG. 1 shows a construction robot 10 with an undercarriage 12 designed as a track-chain undercarriage, a control space 16, formed in a housing 14, and a manipulator 18 arranged on top of the housing 14. The manipulator 18 is designed as a multiaxially controllable arm, at the free end of which an end effector 20 with a drilling power tool 22 arranged thereon and a dust extraction device 24 is arranged. The construction robot 10 is not limited to this configuration. In particular, instead of or in addition to the drilling power tool 22, it may comprise one or more other electrical power tools and/or one or more other devices for performing construction tasks, in particular for performing inspection tasks, a measuring tool such as for example an image sensor and/or a length meter, for example a transit time distance meter or a LIDAR, a cutting tool, a drilling tool, a grinding tool or another tool suitable for performing construction tasks.

The construction robot 10 is designed for performing construction tasks, in particular drilling work in ceilings and walls, on a construction site, for example on a building construction site. In addition to the manipulator 18 for performing the construction tasks assigned to the construction robot 10, it has a computer unit 26 arranged within the housing 14, in particular in the control space 16. The computer unit 26 comprises a storage unit 28.

The computer unit 26 is equipped with executable program code, so that an internal construction task management system 29 with an internal construction task list 30, which comprises one or more construction tasks to be performed by the construction robot 10 on the construction site, is formed by means of the computer unit 26. For this purpose, the internal construction task list 30 is stored in the storage unit 28 in a retrievable manner.

The computer unit 26, and consequently the construction robot 10, also have a communication interface 32 for communication with an external construction task management system, the external construction task management system being set up to store an external construction task list in a retrievable manner, the external construction task list comprising one or more construction tasks to be performed on the construction site,
the construction robot 10 being set up to send at least one construction task and/or a construction task status of a construction task of the internal construction task list 30 to the external construction task management system via the communication interface 32.

The communication interface 32 has a cellular interface according to the 4G or the 5G standard, a WLAN interface, a Bluetooth interface and a USB interface for data transmission using portable USB storage units.

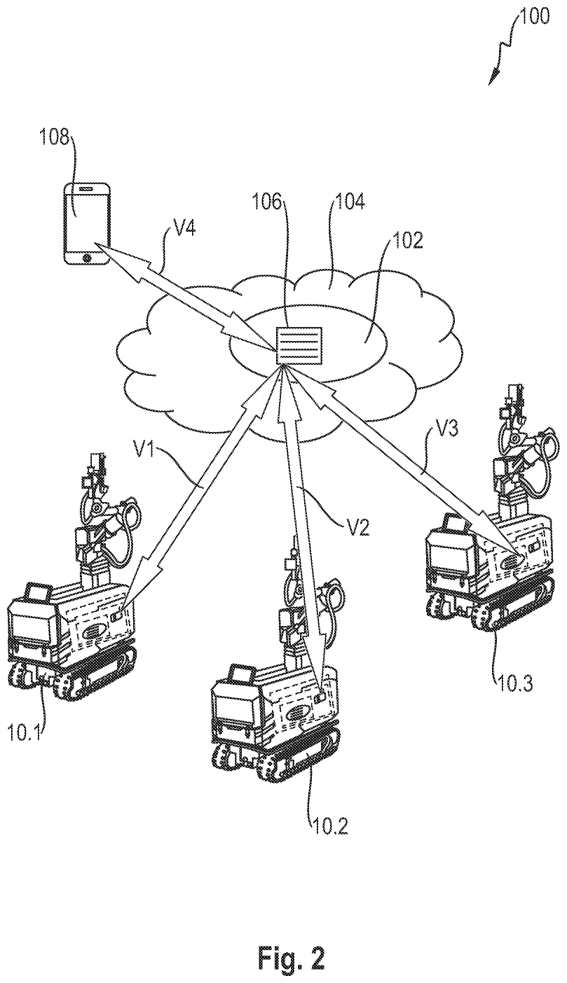

Since the computer unit 26, the storage unit 28, the internal construction task management system 29, the internal construction task list 30 and the communication interface 32 are arranged in the control space 16, and consequently within the housing 14, these, including the control space 16, are schematically shown in FIG. 1 and, if the respective elements are depicted there, also in the further illustrations according to FIG. 2 to FIG. 5.

The construction robot 10 also has a display unit 34, which is designed as a touchscreen. The display unit 34 consequently forms at the same time an input unit for manual data input by a user of the construction robot 10. In particular, the display unit 34 is set up in connection with the computer unit 26 and the internal construction task management system 29 to graphically display the construction tasks contained in the internal construction task list 30, including the construction task statuses assigned to the construction tasks. For this purpose, the display unit 34 is set up to schematically show the construction site or at least a relevant part of the construction site and to graphically display the construction tasks to be performed by the construction robot 10, i.e. drilling, according to the spatial arrangement of the construction tasks in the form of appropriately positioned circles. Depending on the associated construction task status, in this case depending on the respective degree of completion, the circles are shown filled with different colors. The construction tasks as well as the respectively assigned construction task statuses can also be changed manually by the user.

A position detection unit 36 for determining the position and the location of the manipulator 18, and consequently of the construction robot 10, is formed on the end effector 20. For this purpose, the position detection unit 36 may comprise a prism. The position detector unit 36 may also have an angle measurement sensor and/or a length measurement sensor, for example a sensor that measures a light transit time. It is also conceivable that the position detection unit 36 has at least one image sensor. The construction robot 10, in particular the position detection unit 36 and/or the computer unit 26, may have image processing hardware and/or image processing software. The image processing hardware and/or the image processing software can be set up to determine the position and/or the location of the manipulator 18 by means of image data provided by the image sensor. At least one of the two may be set up to implement a SLAM algorithm. They may also be set up to recognize an object and/or a structure, for example a structural element, a borehole, a building element or the like. They may also be set up to determine a position and/or a relative position from this.

The construction robot 10 is also set up to send the position and location of its manipulator 18 determined by means of the position detection unit 36 via the communication interface 32 and to receive corresponding position and location data from other construction robots.

FIG. 2 shows a schematic representation of a first construction robot system 100 for performing construction tasks on a construction site, comprising three construction robots 10.1, 10.2 and 10.3. The number three of the construction robots 10.1, 10.2 and 10.3 is chosen as an example. The construction robot system 100 may also have fewer or more construction robots, in particular construction robots corresponding to the construction robot 10 from FIG. 1 and/or construction robots corresponding to the construction robots 10.1, 10.2 and/or 10.3.

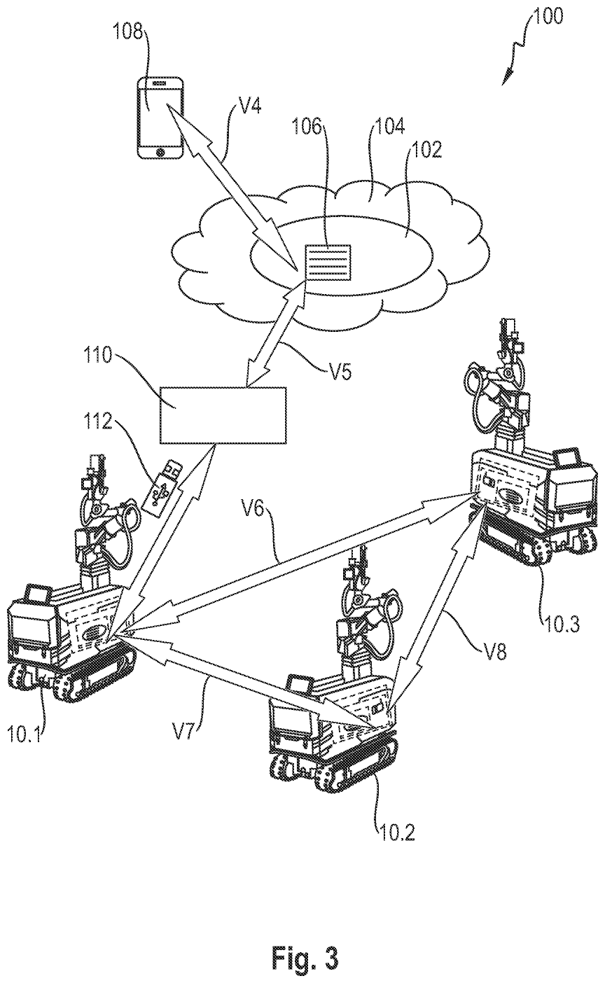

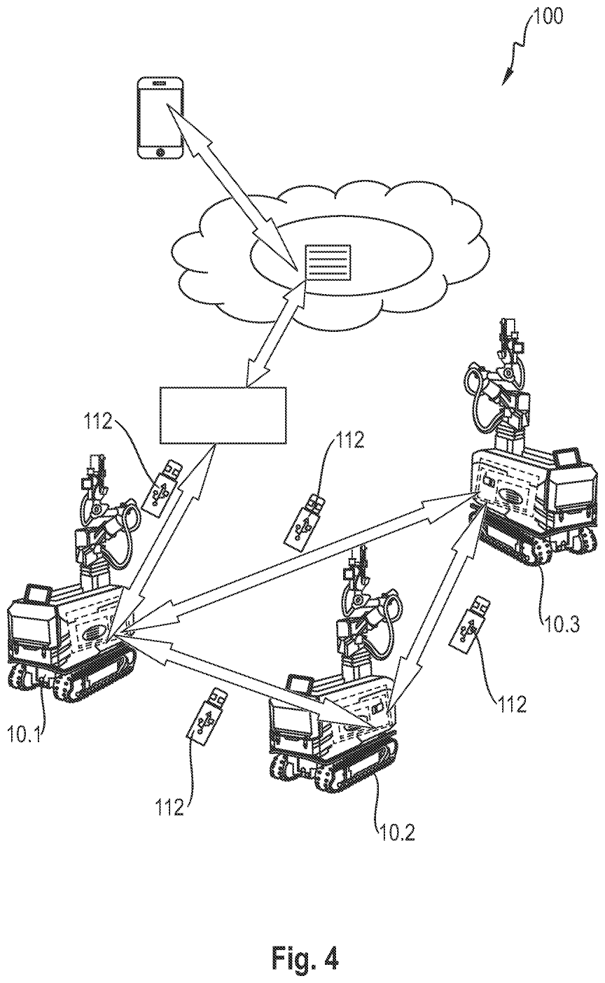

In this exemplary embodiment of a construction robot system 100 and in the exemplary embodiments of construction robot systems 100 described below in connection with FIG. 3 and FIG. 4, the construction robots 10.1, 10.2 and 10.3 correspond in their structure and their functional scope to the construction robot 10 described with reference to FIG. 1. They may have further features beyond the features described above, in particular further functionalities.

The construction robot system 100 also comprises a global construction task management system 102, which is realized by means of a cloud-based computer unit 104 with a storage unit on which a corresponding program code is stored in an executable manner and on which a global construction task list 106 is stored. All of the construction tasks to be performed on the relevant construction site are stored in the global construction task list 106. For this purpose, the global construction task management system 102 is set up to store the global construction task list 106 in a retrievable manner.

The construction robots 10.1, 10.2 and 10.3 are set up to communicate with the global construction task management system 102 via their communication interface 32. For this purpose, data connections V1, V2, V3 can be established via a supra-regional cellular network, for example according to the 4G or 5G standard, in connection with the Internet between the construction robots 10.1, 10.2 and 10.3, in particular their respective communication interfaces 32 and the cloud-based computer unit 104, and consequently the global construction task management system 102, and is set up in the state according to FIG. 2.

The construction robots 10.1, 10.2 and 10.3 can also transmit the positions and locations determined with their position detection units 36 (FIG. 1) to the global construction task management system 102 via the data connections V1, V2 and V3.

The construction robot system 100 also comprises a cell phone 108, which can be connected via a data connection V4, in particular via the supra-regional cellular network, likewise to the cloud-based computer unit 104, and consequently to the global construction task management system 102, and is connected in the state according to FIG. 2.

A user of the cell phone 108 can consequently interrogate the global construction task management system 102 and, for example, obtain an overview of the current construction progress on the construction site concerned.

In this construction robot system 100, initially all of the construction tasks to be performed on the construction site are stored in the global construction task list 106 in the form of BIM planning data.

The construction robots 10.1, 10.2 and 10.3 transmit their respectively determined positions and locations to the global construction task management system 102.

Taking into account the positions and locations of the construction robots 10.1, 10.2 and 10.3, the global construction task management system 102 divides the construction tasks contained in the global construction task list 106 among the construction robots 10.1, 10.2 and 10.3. The construction tasks respectively assigned to the construction robots 10.1, 10.2 and 10.3 are then sent via the data connections V1, V2 and V3 to be performed.

The construction robots 10.1, 10.2 and 10.3 store the construction tasks to be performed in their internal construction task lists 30 (FIG. 1). They then perform them consecutively, in particular the construction robots 10.1, 10.2 and 10.3 drill boreholes corresponding to the construction tasks in ceilings and walls of the construction site.

After each construction task has been completed, the updated associated construction task status, that is to say the completion, is sent to the global construction task management system 102, which then correspondingly updates the global construction task list 106.

As soon as one of the construction robots 10.1, 10.2 or 10.3 has performed all of the construction tasks of its internal construction task list, it interrogates the global construction task management system 102 in order to undertake remaining construction tasks, preferably in its vicinity. If a construction task already assigned to another construction robot 10.1, 10.2 or 10.3 is reallocated or reassigned, the global construction task management system 102 sends a corresponding notification to the corresponding construction robot 10.1, 10.2 or 10.3.

FIG. 3 shows a further construction robot system 100, which, unless otherwise described below, corresponds to the construction robot system 100 described above according to FIG. 2.

One difference however is that, for example due to their respective location, the construction robots 10.2 and 10.3 cannot establish a data connection to the supra-regional cellular network, and consequently also cannot establish a direct data connection to the global construction task management system 102.

This is also not possible with the first construction robot 10.1. However, there is a data connection V5 via the supra-regional cellular network between a relay station 110 and the global construction task management system 102.

Between the relay station 110 and the first construction robot 10.1, data can be exchanged by means of a portable storage unit 112 designed as a portable USB storage unit.

If the construction robot 10.1 can establish a connection to the supra-regional cellular network, it is possible to dispense with the relay station 110 in favor of a direct connection between the construction robot 10.1 and the supra-regional cellular network.

Furthermore, data exchange via data connections V6, V7 and V8 between the construction robots 10.1, 10.2 and 10.3 is possible via their respective communication interfaces 32 (FIG. 1), in particular their WLAN interfaces.

As a departure from the previous exemplary embodiment, in the case of this construction robot system 100 the global construction task management system sends data, in particular construction tasks and/or construction task statuses, via the relay station 110 and by means of the portable storage unit 112 first to the construction robot 10.1, which if necessary correspondingly forwards the data to the construction robots 10.2 or 10.3.

Data to be forwarded to the global construction task management system 102 are collected by the construction robot 10.1 until the next data transmission via the portable storage unit 112 and then collectively transmitted to the relay station 110 for forwarding to the global construction task management system 102.

To extend the range of the WLAN network, the construction robots 10.2 and 10.3 may also pass data through.

If the data connection between the relay station 110 and the global construction task management system 102 fails, in particular temporarily, or if there is no data transmission via portable storage unit 112, for example over a predeterminable minimum time period, the construction robots 10.1, 10.2 and 10.3 or the respective internal construction task management systems 29 (FIG. 1) change their mode of operation.

In particular, after a change in their respective internal construction task list 30 (FIG. 1), in each case they send this to the other two of the construction robots 10.1, 10.2, 10.3, so that each of the construction robots 10.1, 10.2 and 10.3 can compile and use a local copy of the global construction task list 106.

FIG. 4 shows a further construction robot system 100, which, unless otherwise described, corresponds to the construction robot system 100 described with reference to FIG. 3.

As a difference from this however, in the situation shown in FIG. 4, no WLAN data connections can be established between the construction robots 10.1, 10.2 and 10.3 either. Such a situation can arise, for example, in multi-story highrise buildings or underground structures, in particular made of iron-reinforced concrete, in particular when the construction robots 10.1, 10.2 and 10.3 are separated from one another by load-bearing walls or ceilings.

In this situation, data transmissions between the construction robots 10.1, 10.2 and 10.3 therefore take place by means of one or more portable storage units 112.

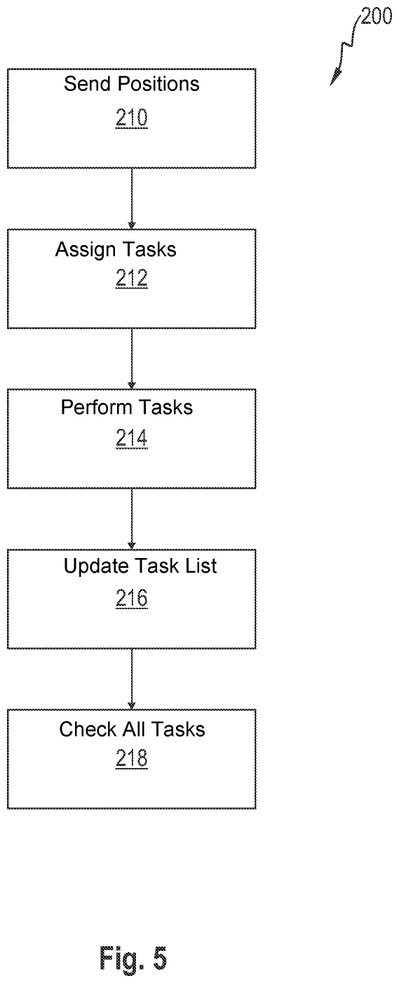

FIG. 5 shows a flow diagram of a variant of the method according to the invention in the form of the method 200. For a better understanding of the invention, the method 200 is explained in more detail with reference to the reference signs introduced in FIG. 1 to FIG. 4 for elements of the construction robots 10.1, 10.2, 10.3 and the construction robot systems 100.

In a preparatory step 210, the construction robots 10.1, 10.2, 10.3 send the positions and locations determined by their position detection units 36 to the global construction task management system 102. In variants of the method, information about features and/or statuses of the construction robots 10.1, 10.2, 10.3, for example about their availability, about available tools, for example types of available drilling tools, or the like, are also transmitted.

In a distribution step 212, the global construction task management system 102 assigns the construction tasks still to be performed to the construction robots 10.1, 10.2, 10.3, taking into account the data obtained in preparation step 210, in particular the positions and locations, and sends the assigned construction tasks to the respective construction robots 10.1, 10.2, 10.3. The construction robots 10.1, 10.2, 10.3 store the received construction tasks in their internal construction task lists.

Alternatively, it is also conceivable that a user of the method 200 or of the construction robot system 100 performs the assignment manually, for example by means of the cell phone 108, and/or manually adds construction tasks to the respective internal construction task list for one or more of the construction robots 10.1, 10.2 and 10.3.

In a performance step 214, the construction robots 10.1, 10.2, 10.3 perform the construction tasks of their internal construction task lists. In a variant of the method, it may be provided that the construction tasks contained in the internal construction task lists can be changed manually by the user of the method 200 or of the construction robot system 100. It is also conceivable that the user must confirm or confirms the performances of construction tasks manually before starting the performance. During and/or after the performance of a construction task, the construction robots 10.1, 10.2, 10.3 store an associated construction task status in their respective internal construction task lists. In particular, they save whether a task could be performed successfully or whether an error, and if so which error, occurred while it was being performed. If necessary, it may be provided in this performance step 214 that the construction robots 10.1, 10.2, 10.3 change their location and, in particular accordingly to one or more of the construction tasks to be performed by them, go to a different location on the construction site. Relocations may take place autonomously. Alternatively, it is conceivable that the user monitors and/or manually controls a necessary relocation.

In an updating step 216, the construction robots 10.1, 10.2, 10.3 send the construction task statuses stored in their internal construction task lists 30 to the global construction task management system 102 by means of their respective communication interfaces 32. This updates its global construction task list 106.

In alternative method variants, for example if no data connection to the global construction task management system 102 can be established, the construction robots 10.1, 10.2, 10.3 exchange construction tasks and construction task statuses, as described above for FIG. 3 or 4, with one another.

In a final step 218 of the method 200, the global construction task management system 102 checks whether all of the construction tasks have been performed successfully.

When all of the construction tasks that can be performed by the construction robots 10.1, 10.2, 10.3 have been performed entirely successfully, the method 200 ends. It may be able to be executed again, especially with new construction tasks.

In the event of incorrect performances, the global construction task management system 102 sends a malfunction message to the cell phone 108, which then notifies the user of this and asks the user to enter a decision on how to proceed. The user's input is transmitted from the cell phone 108 to the global construction task management system 102. According to the decision or the input of the user, the method 200 is aborted or continued with the construction tasks not yet fully performed with the preparation step 210, in an alternative method variant with the distribution step 212.

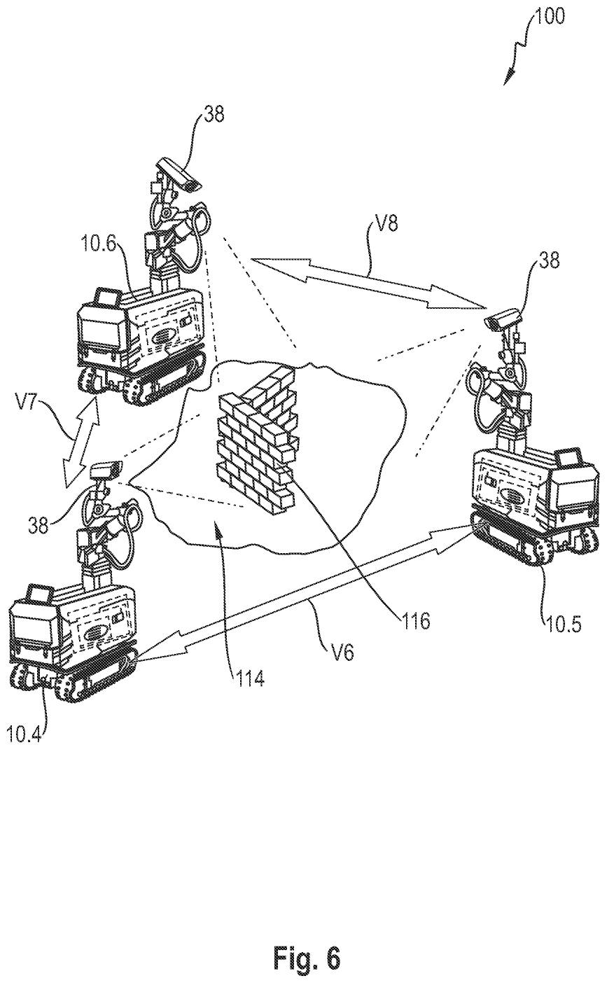

FIG. 6 shows a further construction robot system 100, which, unless otherwise described, corresponds to the construction robot system 100 described with reference to FIG. 2.

It has three construction robots 10.4, 10.5 and 10.6, which, unless otherwise described below, correspond to the construction robots 10.1, 10.2 and 10.3 according to FIG. 2.

In a further exemplary embodiment, the construction robot system 100, unless otherwise described, may also correspond to the construction robot system 100 and in particular to its construction robots 10.1, 10.2 and 10.3 according to FIG. 3.

FIG. 6 does not show a global construction task management system 102 or a computer unit 104 or a global construction task list 106. In an alternative embodiment, however, the construction robot system 100 may also comprise at least one of these elements 102, 104, 106, in particular the global construction management system 102 with the global construction task list 106, for example analogously to the embodiments described with reference to FIG. 2, FIG. 3 or FIG. 4.

A special feature of the construction robots 10.4, 10.5 and 10.6 is that they each have an image sensor 38. The image sensor 38 may for example comprise a 3D camera and/or a 2D camera. It may be set up to record optical image data. The image data may comprise distance information, for example in the form of a three-dimensional image. They may also contain position information and/or location information. For each of the image sensors 38, associated fields of view are schematically shown in FIG. 6 by dashed lines.

It can be seen that, in particular if at least their image sensors 38 are in different positions and/or at different locations, the construction robots 10.4, 10.5 and 10.6 sense with their respective image sensors 38 different areas of a construction site 114, and in particular of a structural element 116 located on the construction site, for example a wall element. The areas preferably complement one another. The construction site 114 may be a building construction site, for example for the construction of a building with steel-reinforced concrete.

The construction robots 10.4, 10.5, 10.6 are set up to send, via their data connections V6, V7, V8 and possibly via a data connection to a global construction task management system, image data recorded by their respective image sensors 38 to one of the other two construction robots 10.4, 10.5 or 10.6 and possibly to the global construction task management system.

The construction robot system 100 can consequently perform construction tasks designed as inspection tasks with a particularly short total duration. In particular, one or preferably more of the construction robots 10.4, 10.5, 10.6 may be involved in completing the same inspection task. For example, construction progress of the construction site 114, and in particular a degree of completion of the structural element 116, may have to be inspected as an inspection task. For this purpose, the construction robots 10.4, 10.5 and/or 10.6 involved may record image data of the construction site 114, and in particular of the structural element 116, with their respective fields of view and by means of the image sensors 38. Since the construction robots 10.4, 10.5 and/or 10.6 involved can optically record the image data simultaneously from different directions of view of the construction site 114, and in particular of the structural element 116, the inspection task can be performed simultaneously by the construction robots 10.4, 10.5 and/or 10.6 involved. For this purpose, each of the construction robots 10.4, 10.5 and/or 10.6 involved may optically record a part of the construction site 114 that corresponds to its field of view. One of the construction robots 10.4, 10.5 and/or 10.6 involved, for example construction robot 10.4, may collect the individual image data. For this purpose, the other of the construction robots 10.4, 10.5 and/or 10.6 involved send their image data to the collecting construction robot, that is to say in the example to construction robot 10.4. In this exemplary embodiment, the transmitted image data may also correspond to a transmission of construction task statuses, since the recorded image data respectively correspond to the completion of part of the inspection task to be performed.

It goes without saying that the positions and/or locations of the construction robots 10.4, 10.5 and/or 10.6 involved and/or their respective image sensors 38 can be changed, for example by driving with the undercarriage 12 (FIG. 1) and/or adjusting the manipulator 18 (FIG. 1), for example in order to bring areas of the construction site 114 to be inspected into one of the fields of view of at least one of the construction robots 10.4, 10.5 and/or 10.6 involved.

The exemplary embodiment is also not limited to the three construction robots 10.4, 10.5 and 10.6. In particular, the construction robot system 100 may have only two construction robots; it may alternatively also have more than three construction robots.

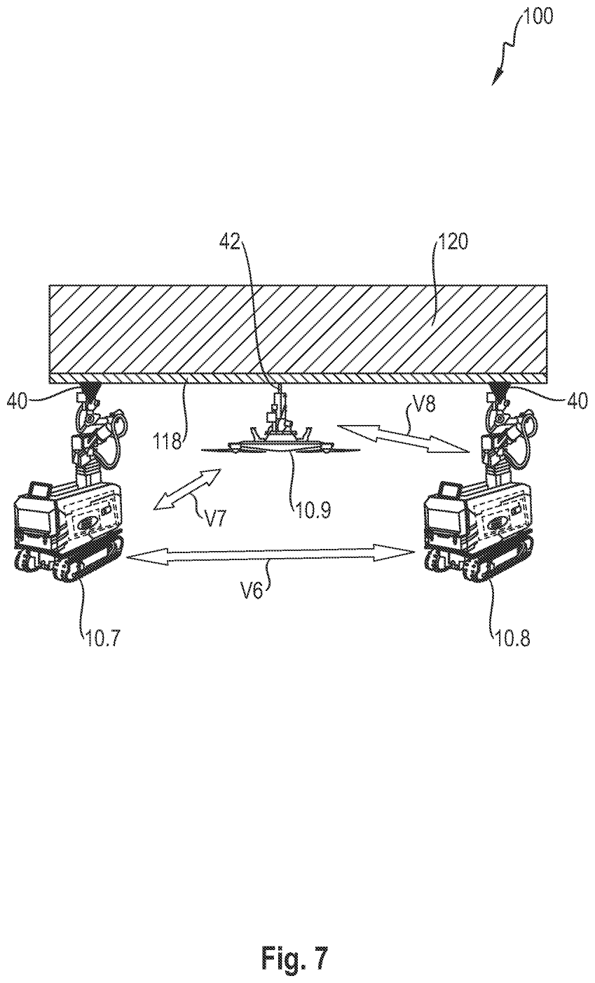

FIG. 7 shows a further construction robot system 100, which, unless otherwise described, corresponds to the construction robot system 100 described with reference to FIG. 2.

It has three construction robots 10.7, 10.8 and 10.9, which, unless otherwise described below, correspond to the construction robots 10.1, 10.2 and 10.3 according to FIG. 2.

In a further exemplary embodiment, the construction robot system 100, unless otherwise described, may also correspond to the construction robot system 100 and in particular to its construction robots 10.1, 10.2 and 10.3 according to FIG. 2.

FIG. 7 does not show a global construction task management system 102 or a computer unit 104 or a global construction task list 106. In an alternative embodiment, however, the construction robot system 100 may again, by analogy with the exemplary embodiments with reference to FIG. 6, comprise at least one of these elements 102, 104, 106, in particular the global construction management system 102 with the global construction task list 106, for example by analogy with the embodiments described with reference to FIG. 2, FIG. 3 or FIG. 4.

In the exemplary embodiment shown in FIG. 7, a first structural element 118, for example a plate-shaped structural element such as a cover plate, is to be fixed on a second structural element 120, for example a ceiling element, in particular of a concrete ceiling.

For this purpose, the first structural element 118 has to be brought to a mounting position on the second structural element 120 and held in this mounting position by at least one of the construction robots 10.7, 10.8 and/or 10.9, here for example by the two construction robots 10.7 and 10.8. At least one other of the construction robots 10.7, 10.8 and/or 10.9, here for example the construction robot 10.9, then sets a fixing element for fixing the first structural element 118 on the second structural element 120, for example a nail that is set by means of a direct setting device.

This exemplary embodiment consequently represents the completion of a construction task as an example of a general exemplary embodiment, in which at least two construction robots each undertake different subtasks, here bringing and holding the first structural element 118 as well as fixing the first structural element.

For this purpose, gripping tools 40 are arranged on the end effectors 20 (FIG. 1) of the two construction robots 10.7 and 10.8. The gripping tools 40 may have a gripping portion for gripping the first structural element 118. The gripping portion may have at least one suction device. Alternatively or additionally, it may also have at least one set of gripping tongs.

In order to bring the first structural element 118 to the mounting position and to hold it there, the two construction robots 10.7 and 10.8 grip the first structural element 118 by means of their gripping tools 40. They then move their manipulators 18 (FIG. 1) synchronously in such a way that the first structural element 118 reaches the desired mounting position and remains at this mounting position.

For synchronization, for example, the construction robot 10.7 sends in each case the construction robot 10.8 status data of itself, for example the next position and/or position data to be reached by its gripping tool 40. With regard to the (partial) construction task to be performed of bringing the first structural element 118 to the mounting position, these position and location data consequently correspond to a construction task status. For example, reaching and staying at the mounting position may correspond to complete completion.

The construction robot 10.8 then moves its gripping tool 40 according to the received position and location data, and preferably taking into account properties of the first structural element 118 and/or the second structural element 120, for example to positions at which the first structural element 118 can be gripped by the construction robot 10.8 and/or to where the first structural element 118 is to be moved by the construction robot 10.8.

After reaching the mounting position, the construction robots 10.7 and 10.8 send a completed signal to the construction robot 10.9 via their data connections V7 and/or V8 as a construction task status. The construction robot 10.9 then moves to all positions, one after the other, at which fixing elements are to be set by means of its direct setting device 42, in particular for fastening the first structural element 118 on the second structural element 120, and correspondingly sets the respective fixing elements, for example nails.

In this exemplary embodiment, the construction robot 10.9 is designed as an unmanned flying object, in particular as a multicopter. In alternative exemplary embodiments, the construction robots 10.7, 10.8, 10.9 may also have other designs, in particular other mobile platforms, than those shown in FIG. 7. The choice of the mobile platform may depend for example on the maximum forces to be applied, the stability, the flexibility, the achievable speeds, or similar parameters.

### LIST OF REFERENCE SIGNS

10, 10.1, 10.2, 10.3,
10.4, 10.5, 10.6, 10.7, 10.8, 10.9 Construction robots
12 Undercarriage
14 Housing
16 Control space
18 Manipulator
20 End effector
22 Drilling power tool
24 Dust extraction device
26 Computer unit
28 Storage unit
29 Internal construction task management system
30 Internal construction task list
32 Communication interface
34 Display unit
36 Position detection unit
38 Image sensor
40 Gripping tool
42 Direct setting tool
100 Construction robot system
102 Global construction task management system
104 Computer unit
106 Global construction task list
108 Cell phone
110 Relay station
112 Storage unit
114 Construction site
116 Structural element
118 First structural element
120 Second structural element
200 Method
210 Preparation step
212 Distribution step
214 Performance step
216 Updating step
218 Final step
V1, V2, V3, V4, V5, V6, V7, V8 Data connection

What is claimed is:

1-15. (canceled)

16. A construction robot for performing construction tasks on a construction site, the construction robot comprising:
at least one manipulator for performing a construction task;
an internal construction task management system set up to store an internal construction task list of the construction robot in a retrievable manner, the internal construction task list including one or more construction tasks to be performed by the construction robot on the construction site; and
a communication interface for communication with an external construction task management system, the external construction task management system being set up to store an external construction task list in a retrievable manner, the external construction task list including one or more construction tasks to be performed on the construction site, the construction robot being set up to send at least one construction task or a construction task status of a construction task of the internal construction task list to the external construction task management system via the communication interface.

17. The construction robot as recited in claim 16 wherein the communication interface is set up for data transmission via a portable storage unit.

18. The construction robot as recited in claim 16 further comprising a position detector for determining a position or a location of the construction robot.

19. The construction robot as recited in claim 18 wherein the position detector determines a position or a location of the manipulator.

20. The construction robot as recited in claim 16 wherein the construction robot is set up to send at least one measurement data item.

21. The construction robot as recited in claim 20 wherein the at least one measurement data item is at least one position or one location of the construction robot or of the manipulator or of another construction robot or of another manipulator.

22. The construction robot as recited in claim 20 wherein the construction robot is set up to send the measurement data item to another construction robot.

23. A construction robot system for performing construction tasks on a construction site, the construction robot system comprising:
a first construction robot being the construction robot as recited in claim 16 and the external construction task management system set up to store the external construction task list in a retrievable manner, the first construction robot being set up to communicate via the communication interface with the external construction task management system.

24. The construction robot system as recited in claim 23 wherein the external construction task management system includes a global construction task management system set up to store a global construction task list in a retrievable manner, the global construction task list including one or more construction tasks to be performed on the construction site.

25. The construction robot system as recited in claim 23 further comprising at least one second construction robot including: at least one second manipulator for performing a second construction task, a second internal construction task management system set up to store a second internal construction task list of the second construction robot in a retrievable manner, the second internal construction task list including one or more second construction tasks to be performed by the second construction robot on the construction site, and a second communication interface, the external construction task management system comprising the second internal construction task management system of the second construction robot.

26. The construction robot system recited in claim 25 wherein the first construction robot is set up to send the at least one construction task or the at least one construction task status to the second construction robot or to a global construction task management system via the communication interface.

27. The construction robot system as recited in claim 23 further comprising a relay station for transmitting at least one construction task or at least one construction task status.

28. The construction robot system as recited in claim 23 wherein the construction robot system is set up such that a construction task is completed by the first construction robot and a second construction robot including at least one second manipulator for performing a second construction task, a second internal construction task management system set up to store a second internal construction task list of the second construction robot in a retrievable manner, the second internal construction task list including one or more second construction tasks to be performed by the second construction robot on the construction site, and a second communication interface.

29. The construction robot system as recited in claim 28 wherein the first construction robot sends at least one construction task status to the second construction robot.

30. A method for controlling at least one construction robot of a construction robot system as recited in claim 23, the method comprising sending the at least one construction task or construction task status of the internal construction task list of the first construction robot to the external construction task management system.

31. The method as recited in claim 30 wherein the at least one construction task or construction task status of the internal construction task list of the first construction robot is sent to an internal construction task management system of a second construction robot.

32. The method as recited in claim 30 wherein the at least one construction task or construction task status of the internal construction task list of the first construction robot is sent to a global construction task management system.

33. A method for operating the construction robot as recited in claim 16 comprising operating the robot on a building construction site or a civil engineering construction site.
